(19) United States
(12) Patent Application Publication
(10) Pub. No.: US 2022/0244089 A1
(43) Pub. Date: Aug. 4, 2022

(54) Device And Method For Sensing Information Relating To The Fill Level Of A Container Storing Fluid

(71) Applicant: Messer GasPack GmbH, Krefeld (DE)

(72) Inventor: Alexander Kriese, Baden bei Wien (AT)

(73) Assignee: Messer GasPack GmbH, Krefeld (DE)

(21) Appl. No.: 17/613,550

(22) PCT Filed: May 11, 2020
(86) PCT No.: PCT/EP2020/063088

§ 371 Date: Nov. 23, 2021

(30) Foreign Application Priority Data
May 28, 2019 (DE) 102019003767.7

(51) Int. Cl. G01F 23/296; G01F 1/66

(52) U.S. Cl. CPC G01F 23/2966; G01F 1/666

(57) ABSTRACT

A device for sensing information relating to the fill level of a container storing fluid, the container being equipped with a fill- and/or discharge line and a fill- and/or discharge fitting provided therein, is equipped with: a microphone positioned on the fill- and/or discharge line, for sensing an acoustic signal as the fluid passes through said fill- and/or discharge line; means for transmitting the acoustic signals sensed by the microphone to an evaluation unit; and an evaluation unit. The evaluation unit has a memory unit storing a characteristic curve containing information relating to the modification of a characteristic parameter according to the container contents, a computer unit determining a characteristic parameter from the acoustic signal sensed by the microphone, a comparison unit comparing the characteristic parameter and identifying information concerning the container contents, and a display unit which visually displays the information relating to the container contents.

### CROSS-REFERENCE TO RELATED APPLICATIONS

This application is the U.S. national stage application of International Application No. PCT/EP2020/063088, filed May 11, 2020, which International Application was published on Dec. 3, 2020, as International Publication WO 2020/239422 A1 in the German language. The International Application claims priority to German Application No. 10 2019 003 767.7, filed May 28, 2019. The International Application and German Application are hereby incorporated herein by reference, in their entireties.

### FIELD

The invention relates to a device and a method for sensing information relating to the fill level of a container storing fluid.

### BACKGROUND

Various technologies, such as e.g. aperture measurement, oval wheel meters or variable area flowmeters, exist for measuring the flow of fluids, such as, for example, liquids, gases or bulk materials, through lines. For many of these methods, a measuring device comes into direct contact with the fluid. As a result of the precautions which are therefore required in the case of fluids which are under pressure or at high temperatures and which are aggressive, i.e. in particular abrasive, explosive, flammable, corrosive or oxidative fluids, or in which a combination of the aforementioned factors applies, measuring devices of this type incur high costs.

Systems for measurement without media contact, such as, for example, magnetic-inductive-operating systems, Coriolis mass flow meters or ultrasound measurement systems, also exist, but are subject to certain restrictions and similarly incur high costs. Flow measurement devices which operate with ultrasound are known, for example, from DE 10 2014 106 706 A1, EP 1 413 858 A1 or U.S. Pat. No. 5,546,813 B1.

For measuring fill levels in fluid-filled containers, measurement systems are used which measure the pressure in the container or in an outgoing line from the container. The known systems are capable of determining the container pressure and therefore the fill level of the container with a high precision, but require direct contact of a sensor with the fluid stored in the container, this being associated with disadvantages and in some instances incurring substantial costs for the aforementioned reasons. Further measurement principles are also used, for example mass measurement or ultrasound measurement of phase boundaries, which in each case have specific advantages and disadvantages.

In many cases, the knowledge of an exact value for the fill level in the container is in no way necessary. If the information relating to the fill level in the container is intended to be used, for example, simply to determine whether the container is almost emptied and must soon be replaced, this information can already be obtained from a very rough value of the container pressure or the fill level.

### SUMMARY

The object of the invention is therefore to provide a device which is of simple design and can be implemented at low cost, and which allows information to be obtained relating to the fill level of the fluid-filled container.

This object is achieved by a device with the features of patent claim 1.

### DETAILED DESCRIPTION

A device according to the invention for sensing information relating to the fill level of a container storing a fluid, said container being equipped with a fill and/or discharge line and with a fill and/or discharge fitting arranged in the fill and/or discharge line comprises a microphone arranged on the fill and/or discharge line or on a body of the container for detecting an acoustic signal as fluid passes through the fill and/or discharge line, means for transmitting the acoustic signal detected by the microphone to an evaluation unit which comprises a memory unit for storing a characteristic curve which contains information relating to the change in a characteristic parameter depending on the container pressure and, where appropriate, the fluid temperature, a computer unit which determines a current value for the characteristic parameter from the acoustic signal detected by the microphone, and a comparison unit which compares the current value for the characteristic parameter determined in this way with the characteristic curve stored in the memory and calculates information relating to the container contents therefrom, and a display unit integrated into or having a data connection to the evaluation unit with which the information relating to the container contents can be displayed to an operating person.

The characteristic parameter is a parameter which is to be determined from the acoustic spectrum, for example the frequency, a combination of a plurality of frequencies or a frequency range with a maximum amplitude, the strength of the complete signal or a different spectral characteristic. An essential feature of the characteristic parameter is that it changes along with a changing volume flow of the fluid through the fill and/or discharge line (this could be described colloquially as an “acoustic fingerprint” of a flow). If the volume flow of the fluid changes, the value for the characteristic parameter therefore changes simultaneously, thus being suitable for providing information relating to the fill level in the container (also referred to here as the “container contents”).

An exact value for the container contents cannot necessarily be determined from the value for the fill level determined with the device according to the invention. However, it suffices in many applications to supply an operating person with the information which he requires relating to the fill level in the container, such as, for example, information indicating whether the fluid quantity present in the container is still expected to be sufficient to complete an intended task. It suffices accordingly for the display unit to display the fill level quite roughly, for example as a percentage value or a fraction of the maximum fill level, or in a color coding.

The device according to the invention preferably serves to obtain information relating to the fill level of a pressurized gas bottle or a pressurized gas bottle bundle during the filling with gas or the discharge of gas into or out of the container. Pressurized gas containers of this type are known and are used, for example, to store air gases such as nitrogen, oxygen or argon, carbon dioxide or gas mixtures, in particular welding gas mixtures. They have a maximum operating pressure of normally between 10 bar and 500 bar, in particular of around 200 bar or around 300 bar, and have a volume between 1 l and 150 l and have a valve as a fill and/or discharge fitting via which both the filling and the discharge of the gas take place (referred to below as the “valve”). However, the invention is furthermore usable for larger containers also, for example standing tanks or tanks mounted on trailers which can hold several thousand liters. In the case of pressurized gas bottles, the microphone and/or the evaluation unit can be mounted, for example, directly on the valve, or the evaluation unit is located together with the display unit in a protective device for the valve permanently mounted on the pressurized gas bottle and has a data connection to a microphone mounted on the valve or on a line section connected to the valve. In the case of pressurized gas bottle bundles, the microphone is preferably arranged on a collector line interconnecting the pressurized gas bottles of the bundle, and the evaluation unit is preferably arranged inside a bundle rack enclosing the pressurized gas bottles of the bundle.

One preferred design of the invention provides that the evaluation unit has a data connection to at least one sensor for measuring the ambient temperature and/or the temperature of the discharge line and/or the temperature of the fluid in the container. These temperatures can influence the acoustic signal of the fluid passing through the fill and/or discharge line and can therefore distort the calculated value for the fill level. The measurement of said temperatures enables a corresponding correction of the value calculated in the comparison unit for the container pressure or the fill level in the container.

The microphone is appropriately equipped with sound insulation to shield against acoustic signals which originate from sources outside the discharge line and can interfere with the measurement signal.

In a first preferred design of the invention, the evaluation unit is similarly arranged on the container and has a data connection to the microphone, for example via a cable connection. In a different embodiment of the invention, a transmitter is assigned to the microphone and a receiving unit is assigned to the evaluation unit to receive the signals emitted by the transmitter. In this design, the evaluation unit can also be arranged spatially distant from the microphone, for example in a computer of a control center or on the smartphone of a user. In this way, a remote monitoring of the fill level is possible. If the evaluation unit is installed on a smartphone or other mobile device, it is advisable to design the transmitter and the receiving unit in such a way that a communication via Bluetooth or other short-range data transmission is possible. A further different design of the device according to the invention provides that the microphone and/or the evaluation unit is/are installed in a mobile device. Both elements can be installed in the same device or in different devices. Both elements can be installed, for example, in a smartphone, wherein the microphone already pre-installed in the smartphone is used as the microphone within the meaning of the invention, or a mobile microphone is used which has a wired or wireless data connection to a smartphone in which the evaluation unit is installed. It is similarly conceivable for the display unit to be separated from the evaluation unit and to be in contact with the latter via a suitable, for example wireless, data connection.

In a further advantageous design of the invention, the evaluation unit is designed in such a way that it the direction of flow of the fluid through the fill and/or discharge line is determinable therewith. For this purpose, for example, characteristic curves for filling procedures or characteristic parameter curves are additionally also present in the memory of the evaluation unit, by means of which the direction of flow can be determined.

A method according to the invention for sensing information relating to the fill level of a container storing a fluid using a device according to the invention is characterized by the following steps:
a. when fluid is discharged from the container or the container is filled with fluid by opening the fill and/or discharge fitting, an acoustic measurement signal generated as the fluid passes through the fill and/or discharge line is detected by the microphone,
b. a characteristic parameter is determined from the acoustic measurement signal,
c. the characteristic parameter of the measurement signal is compared with a characteristic curve which contains information relating to the change in the characteristic parameter depending on the container contents,
d. information relating to the container contents is determined through the comparison with the characteristic curve,
e. the information relating to the contents is transmitted to a display unit and is displayed by the latter.

Steps b. to d. take place as electronic processes in the evaluation unit of the device according to the invention which exchanges data either directly, for example via cable, or in a remote data connection with the microphone. Step e. takes place in the evaluation unit insofar as the display unit is part of the evaluation unit. However, it is equally conceivable for the information to be transmitted via cable or wirelessly from the evaluation unit to an external display unit which is installed, for example, in an external computer or a smartphone.

The characteristic curve is preferably determined by the following procedure: the container is first filled with fluid, and the fluid is then completely removed via the discharge line by opening the discharge fitting. While the fluid passes through the discharge line, an acoustic signal generated by the fluid in the discharge line is detected continuously or at predefined time intervals by means of the microphone. The value of the respective characteristic parameter is determined from the measured values continuously or at predefined time intervals corresponding to different fill levels or pressure values in the container, said values being combined to form a characteristic curve which describes the change in the characteristic parameter of the fill level or the container pressure. This characteristic curve is stored in the memory unit of the evaluation unit as a reference for the values for the characteristic parameter determined during a subsequent fluid discharge. A corresponding characteristic curve for the filling of a container can be determined in a similar manner.

The characteristic curves can furthermore be determined on the same container on which the later measurement is also carried out, for example before the initial handover of the container to a customer or during a routine checking of the container, or a characteristic curve is determined on a standard container which is representative of all containers of the same type which are to be filled with the same fluid and are equipped with the same fill and/or discharge fittings, and this characteristic curve is input into a plurality of memory units as a standard characteristic curve.

The ambient temperature and/or the external temperature of the discharge line and/or the temperature of the fluid in the container is/are preferably additionally measured and a corrected value for the characteristic parameter is calculated therefrom in the evaluation unit according to a predefined program, said value then being displayed on the display unit.

In a similarly preferred embodiment, in cases where a line opening out into a container is usable as both a fill and a discharge line, the direction of flow of the fluid is determined on the basis of the change over time in the acoustic measurement signal detected on the microphone.

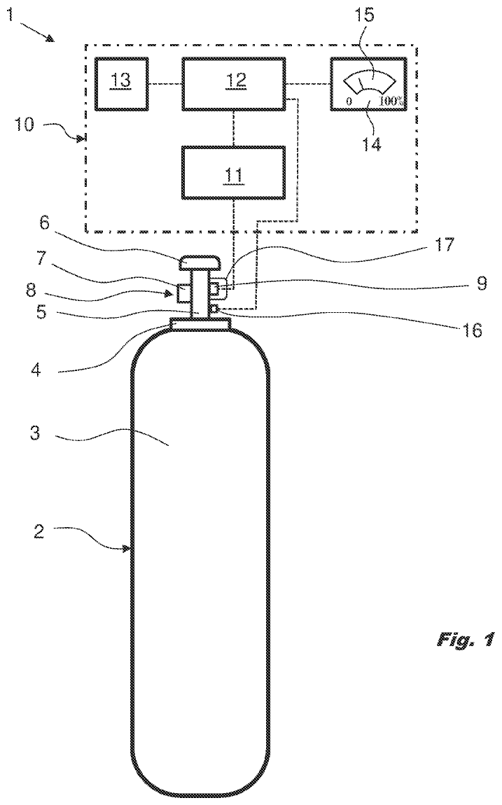

An example embodiment of the invention will be explained in detail with reference to the drawing. The single drawing (FIG. 1) shows schematically a device according to the invention mounted on a pressurized gas bottle.

The device 1 shown in FIG. 1 is a device for sensing information relating to the fill level of a container storing a fluid; in the example embodiment, the container is a pressurized gas bottle 2 in which a gas, for example nitrogen, oxygen, an inert gas or a welding gas mixture, is stored at a pressure of, for example, 200 bar or 300 bar. The pressurized gas bottle 2 has a body 3 preferably made of steel with a volume of, for example, between 1 l and 150 l. A valve 5 with a handwheel 6 and a side nozzle 7 is arranged on the neck 4 of the pressurized gas bottle 2. According to the invention, the valve 5 is designed as part of a discharge line 8 for supplying a consumer (not shown here) with gas from the pressurized gas bottle 2.

The device according to the invention comprises a microphone 9 attached externally on the discharge line 8, in the example embodiment shown here on the discharge valve 5, and an electronic evaluation unit 10 which has a data connection to the microphone 9. The microphone 9 is designed so that it can pick up acoustic signals which are produced as the gas passes through the valve 5. Instead of the arrangement on the valve 5 shown here, the microphone 9 can furthermore also be mounted on the external surface of a line connected to the side nozzle 7 or on an external surface of the body 3.

The evaluation unit 10, merely implicitly indicated here by a dashed-dotted line, is preferably mounted on the pressurized gas bottle 2, for example in a valve protection device (not shown here) in the form of a hood or cage which is attached to the neck 4 of the pressurized gas bottle 2.

The evaluation unit 10 comprises a computer unit 11, a comparison unit 12, a memory 13 and a display unit 14. Acoustic signals picked up by the microphone 9 are processed in the computer unit 11 and are used to determine a characteristic parameter. The characteristic parameter is a parameter which is to be determined from the acoustic spectrum, for example the frequency or a frequency range with a maximum amplitude, the strength of the complete signal or a different spectral characteristic. An essential feature of the characteristic parameter is that, with a change in the quantity flow of the gas through the valve 5 or the part of the discharge line 8 on which the microphone 9 is positioned, it similarly changes in a unique manner.

A characteristic curve which describes the change in the characteristic parameter depending on the pressure of the gas in the pressurized gas bottle 2 is stored in the memory 13 for precisely this characteristic parameter. The characteristic curve has preferably been determined empirically in advance, whereby, following a complete filling of the pressurized gas container 2, with the same gas the valve 5 has been opened and, during the ensuing gradual emptying, an acoustic signal produced by the gas passing through the discharge line 8 has been detected continuously or at predefined time intervals by the microphone 9; a sequence of values of the characteristic parameter has been calculated from the acoustic signals detected in this way and a characteristic curve of the characteristic parameter has been formed from said values depending on the simultaneously measured fill pressure in the pressurized gas bottle 2 or the quantity of its contents. The characteristic curve can furthermore be determined on the same pressurized gas bottle 2 or on a different pressurized gas bottle of the same type which has been filled with the same gas, wherein, in the latter case, the characteristic curve is to be input electronically into the memory unit 13.

The comparison unit 12 compares the value for the characteristic parameter determined in the computer unit 11 from the measured acoustic signal with the characteristic curve present in the memory 13 and calculates a value therefrom relating to the approximate pressure range in which the fill pressure of the pressurized gas bottle 2 lies. This value is transmitted to the display unit 14 which presents the corresponding pressure range in a visual display 15 which is very rough but completely adequate for most applications.

A correction factor which describes the influence of the ambient temperature and/or the temperature of the gas in the discharge line 8 and/or the temperature of the gas in the pressurized gas bottle 2 can be taken into account in the value for the pressure range determined by the comparison unit 12. The temperature is displayed by means of a suitable temperature sensor 16 which is arranged in FIG. 1 by way of example directly on the discharge valve 5. The temperature sensor 16 has a data connection to the comparison unit 12 of the evaluation unit 10 which determines the corresponding correction factor from the measured temperature values according to a program present in the evaluation unit 10, and outputs the corrected value of the pressure range to the display unit 14.

In order to minimize interfering influences from acoustic signals originating from sources outside the discharge line 8, the microphone 8 is equipped in one preferred design of the invention with sound insulation 17 on its sides facing away from the side nozzle 7.

Instead of the pressurized gas bottle 2 shown here, fill levels of other containers for storing gaseous or liquid substances can furthermore also be measured with the device 1 according to the invention, for example pressurized gas bottle bundles or tanks in which gas is stored under pressure and/or in the liquefied state.

### LIST OF REFERENCE NUMERALS

1. Device
2. Pressurized gas container
3. Body
4. Neck
5. Valve
6. Handwheel
7. Side nozzle
8. Fill and/or discharge line
9. Microphone
10. Evaluation unit
11. Computer unit
12. Comparison unit
13. Memory
14. Display unit
15. Visual display
16. Temperature sensor
17. Sound insulation

1. A device for sensing information relating to the fill level of a container storing a fluid, said container being equipped with a fill and/or discharge line and with a fill and/or discharge fitting arranged in the fill and/or discharge line, having:
a microphone arranged on the fill and/or discharge line or on a body of the container for detecting an acoustic signal as fluid passes through the fill and/or discharge line;
means for transmitting the acoustic signal detected by the microphone to an evaluation unit which comprises a memory unit for storing a characteristic curve which contains information relating to the change in a characteristic parameter depending on the container contents, a computer unit for determining the characteristic parameter from the acoustic signal detected by the microphone, and a comparison unit for comparing the determined characteristic parameter with the characteristic curve and for determining information relating to the container contents; and
a display unit integrated into or having a data connection to the evaluation unit for displaying the information relating to the container contents.

2. The device as claimed in claim 1, wherein a pressurized gas bottle or a pressurized gas bottle bundle is provided as the container.

3. The device as claimed in claim 1, wherein the evaluation unit has a data connection to at least one sensor for measuring the ambient temperature and/or the temperature of the discharge line and/or the temperature of the fluid in the container.

4. The device as claimed in claim 1, wherein the microphone is equipped with sound insulation to shield against acoustic signals from outside the fill and/or discharge line or the container.

5. The device as claimed in claim 1, wherein the microphone is equipped with a transmitter and the evaluation unit is equipped with a receiving unit to receive an outgoing signal from the transmitter.

6. The device as claimed in claim 1, wherein the microphone and/or the evaluation unit is/are installed in a mobile device.

7. The device as claimed in claim 1, wherein the evaluation unit is designed in such a way that the direction of flow of the fluid through the fill and/or discharge line is determinable therewith.

8. A method for sensing information relating to the fill level of a container storing a fluid, with a device as claimed in claim 1, characterized by the following steps:
a. when fluid is discharged from the container or the container is filled with fluid by opening the fill and/or discharge fitting, detecting an acoustic measurement signal generated as the fluid passes through the fill and/or discharge line by means of the microphone,
b. determining a characteristic parameter from the acoustic measurement signal,
c. comparing the characteristic parameter of the measurement signal with a characteristic curve which contains information relating to the change in the characteristic parameter depending on the container contents,
d. calculating information resulting therefrom relating to the contents of the container,
e. transmitting the information relating to the container contents to the display unit.

9. The method as claimed in claim 8, characterized in that the ambient temperature and/or the external temperature of the fill and/or discharge line and/or the temperature of the fluid in the container is/are additionally measured and is/are used in the evaluation unit to calculate corrected information relating to the container contents.

10. The method as claimed in claim 8, characterized in that the direction of flow of the fluid through the fill and/or discharge line is determined on the basis of the change over time in the acoustic measurement signal.
